(19) United States
(12) Patent Application Publication
(10) Pub. No.: US 2023/0176234 A1
(43) Pub. Date: Jun. 8, 2023

(54) METHOD AND APPARATUS FOR MATCHING IMAGE DATA TELEMETRY PACKETS AND AUXILIARY DATA TELEMETRY PACKETS FOR SATELLITE IMAGE PROCESSING

(71) Applicant: KOREA AEROSPACE RESEARCH INSTITUTE, Daejeon (KR)

(72) Inventor: Jin Hyung PARK, Daejeon (KR)

(73) Assignee: KOREA AEROSPACE RESEARCH INSTITUTE, Daejeon (KR)

(21) Appl. No.: 17/987,979

(22) Filed: Nov. 16, 2022

(30) Foreign Application Priority Data
Dec. 2, 2021 (KR) 10-2021-0171205

(51) Int. Cl. G01S 19/48; G01S 19/28; G01S 19/25

(52) U.S. Cl. CPC G01S 19/485; G01S 19/28; G01S 19/256

(57) ABSTRACT

Provided is a method for matching telemetry packets for satellite image processing, which includes receiving a plurality of image data telemetry packets and a plurality of auxiliary data telemetry packets, the plurality of image data telemetry packets include satellite image data photographed from a satellite, but do not include satellite image sequence information, and the plurality of auxiliary data telemetry packets include satellite image sequence information, correcting a packet time of either the plurality of image data telemetry packets or the plurality of auxiliary data telemetry packets by using a predetermined mathematical formula, and matching the plurality of image data telemetry packets and the plurality of auxiliary data telemetry packets corresponding to the same satellite image sequence by using the packet time.

### CROSS-REFERENCE TO RELATED APPLICATION

This application claims priority under 35 U.S.C § 119 to Korean Patent Application No. 10-2021-0171205, filed in the Korean Intellectual Property Office on Dec. 2, 2021, the entire contents of which are hereby incorporated by reference.

### TECHNICAL FIELD

The present disclosure relates to a method and a system for matching image data telemetry packets and auxiliary data telemetry packets for satellite image processing, and more particularly, to a method and an apparatus for matching image data telemetry packets and auxiliary data telemetry packets, which correct packet time and matching the packets to the same satellite image sequences.

### BACKGROUND ART

Cheollian Satellite 2B Geostationary Environment Monitoring Spectrometer (GEMS) payload has telemetry packet types of image data telemetry packets and auxiliary data telemetry packets.

The image data telemetry packets contain image data observed from a satellite, which is divided and generated 1 frame per image. For Earth observation, 700 times of observations are performed for about 30 minutes, which is once in about every 2.6 seconds. Frequency and number of observations vary depending on the target of observation and settings.

Auxiliary data telemetry is a packet that informs of various state information of a payload, and it may include an observation target (Calibration Wheel Position), a photographing position, and satellite image sequence information. The satellite image sequence information may be provided according to an order in which the satellite images are photographed, such as Mirror Step Count. The auxiliary data telemetry is generated at 1 Hz cycle.

Data Pre-processing System (DPS) is a sub-system of the Cheollian 2B ground station and it receives telemetry of the GEMS payload and performs radiometric correction processing.

The GEMS radiometric correction uses image data telemetry and auxiliary data telemetry. Meanwhile, generation cycles of the image data and the auxiliary data do not coincide with each other, and it is difficult to perform the radiometric correction processing by matching the image data telemetry and the auxiliary data telemetry.

Since the image data telemetry packet does not contain the observation position and the satellite image sequence information, it is necessary to find the auxiliary data telemetry corresponding to the same satellite image sequence as the image data telemetry packet by using a packet time, that is, the satellite on-board time (OBT) of when the packet is generated.

FIG. 1 illustrates an example in which image data telemetry packets and auxiliary data telemetry packets are aligned by packet time, and FIGS. 2 to 4 are views provided to explain an error occurring in the packet matching by packet time.

As illustrated in FIG. 1, the image data telemetry packet (SCI_IMG) and the auxiliary data telemetry packet (TLM_ENG) may be aligned according to the satellite OBT time sequence which is a packet time (Time).

While FIG. 1 illustrates that the Mirror Step, which matches the satellite image sequence information, is written in the image data telemetry packet (SCI_IMG) for the purpose of explanation, the mirror step information is not actually included in the image data telemetry packet (SCI_IMG).

Referring to FIG. 2, when telemetry packets are aligned according to OBT time sequence as shown in FIG. 1, the auxiliary data telemetry packets 11 and 12 (0^{th} Mirror Step TLM_ENG) corresponding to the 0^{th} mirror step are placed before and after the image data telemetry packet 20 (1^{st} Mirror Step SCI_IMG) corresponding to the first mirror step. In addition, the auxiliary data telemetry packets 31 and 32 (1^{st} Mirror Step TLM_ENG) corresponding to the first mirror step are farther away from the image data telemetry packet 20 of the first mirror step than the auxiliary data telemetry packets 11 and 12.

Similarly, referring to FIG. 3, the auxiliary data telemetry packets 31 and 32 (1^{st} Mirror Step TLM_ENG) corresponding to the first mirror step are placed before and after the image data telemetry packet 40 (2^{nd} Mirror Step SCI_IMG) corresponding to the second mirror step. In addition, the auxiliary data telemetry packets 51 and 52 (2^{nd} Mirror Step TLM_ENG) corresponding to the second mirror step are farther away from the image data telemetry packet 40 corresponding to the second mirror step than the auxiliary data telemetry packets 31 and 32.

Similarly, referring to FIG. 4, the auxiliary data telemetry packets 51 and 52 (2^{th} Mirror Step TLM_ENG) corresponding to the 2th mirror step are placed before and after the image data telemetry packet 60 (3^{rd} Mirror Step SCI_IMG) corresponding to the second mirror step. In addition, the auxiliary data telemetry packets 71 (3^{rd} Mirror Step TLM_ENG) corresponding to the third mirror step are farther away from the image data telemetry packet 60 corresponding to the third mirror step than the auxiliary data telemetry packets 51 and 52.

Therefore, when the image data telemetry packets and the auxiliary data telemetry packets are simply aligned according to the satellite OBT time sequence as described above and the image data telemetry packets are matched to the auxiliary data telemetry packets that are immediately before, after, or the closest to the image data telemetry packet by the packet time, incorrect matching occurs.

### SUMMARY

Accordingly, the technical object to be achieved by the present disclosure is to provide a method and an apparatus for matching image data telemetry packets and auxiliary data telemetry packets for satellite image processing.

According to an embodiment of the present disclosure, there is provided a method for matching telemetry packets for satellite image processing, which may include receiving a plurality of image data telemetry packets and a plurality of auxiliary data telemetry packets, wherein the plurality of image data telemetry packets include satellite image data photographed from a satellite, but do not include satellite image sequence information, and the plurality of auxiliary data telemetry packets include satellite image sequence information, correcting a packet time of either the plurality of image data telemetry packets or the plurality of auxiliary data telemetry packets by using a predetermined mathematical formula, and matching the plurality of image data telemetry packets and the plurality of auxiliary data telemetry packets corresponding to the same satellite image sequence by using the packet time.

The method may include matching the image data telemetry packet to an auxiliary data telemetry packet of the auxiliary data telemetry packets that has the closest packet time.

The method may include matching the image data telemetry packet to an auxiliary data telemetry packet of the auxiliary data telemetry packets that has the packet time immediately before or after the packet time of the image data telemetry packet.

The satellite image data may be generated through an image processing process of generating one satellite image frame by combining satellite image sub-frames photographed a plurality of times for the same integration time.

The predetermined mathematical formula may be T_c=T+T_int×N_co-adding×Const+offset, where, ‘T_c’ may be the packet time after correction, ‘T’ may be the packet time recorded in the packet at the time of generating the telemetry packet, ‘T_int’ may be the integration time, ‘N_co-adding’ may be a number of times the satellite image sub-frame is photographed, and ‘Const’ and ‘offset’ may be correction coefficients that may be predetermined.

According to an embodiment of the present disclosure, there is provided an apparatus for matching telemetry packets for satellite image processing, which may include a packet receiving unit configured to receive a plurality of image data telemetry packets and a plurality of auxiliary data telemetry packets, wherein the plurality of image data telemetry packets include satellite image data photographed from a satellite, but do not include satellite image sequence information, and the plurality of auxiliary data telemetry packets include satellite image sequence information, a packet time correction unit configured to correct a packet time of either the plurality of image data telemetry packets or the plurality of auxiliary data telemetry packets by using a predetermined mathematical formula, and a packet matching unit configured to match the plurality of image data telemetry packets and the plurality of auxiliary data telemetry packets corresponding to the same satellite image sequence by using the packet time.

According to an embodiment of the present disclosure, there is provided a computer-readable recording medium which may record a program for executing the above method on a computer.

According to the present disclosure, an image data telemetry packet that does not include satellite image sequence information can be matched correctly to an auxiliary data telemetry packet that corresponds to the same image sequence.

### BRIEF DESCRIPTION OF THE DRAWINGS

The above and other objects, features and advantages of the present disclosure would be described with reference to the accompanying drawings described below, where similar reference numerals indicate similar elements, but not limited thereto, in which:

FIG. 1 shows an example in which image data telemetry packets and auxiliary data telemetry packets are aligned by packet time;

FIGS. 2 to 4 are views provided to explain an error occurring when the image data telemetry and the auxiliary data telemetry packets are matched using packet time;

FIG. 5 illustrates a configuration of an apparatus for matching telemetry packets for satellite image processing;

FIG. 6 illustrates an example in which telemetry packets are aligned according to packet time sequence after packet time correction; and

FIG. 7 is a flowchart illustrating operation of an apparatus for matching telemetry packets for satellite image processing.

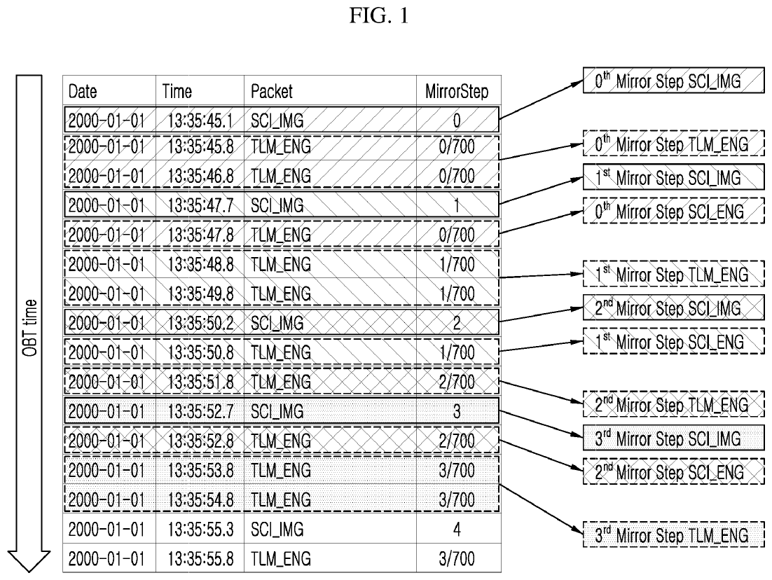

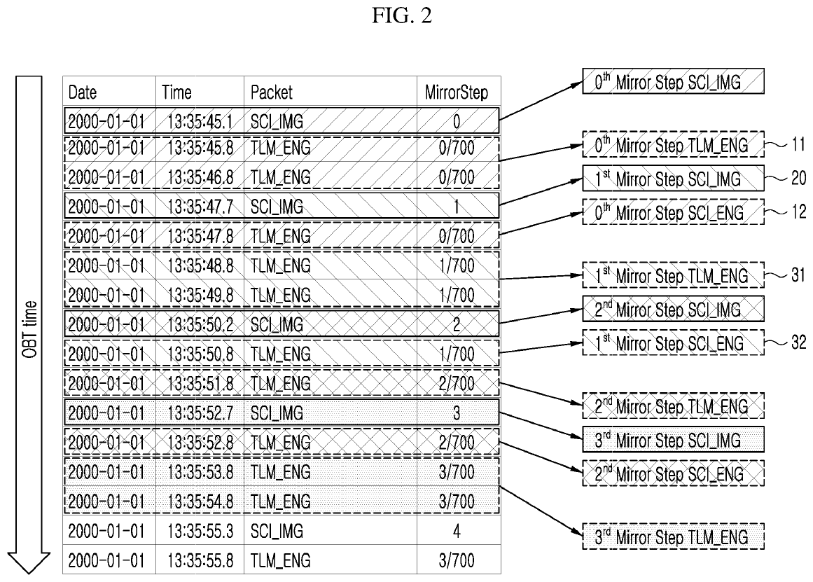

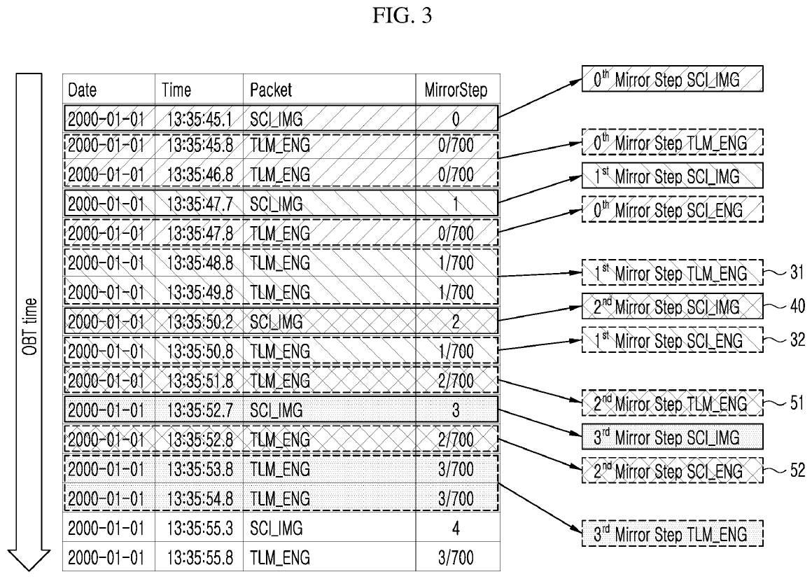

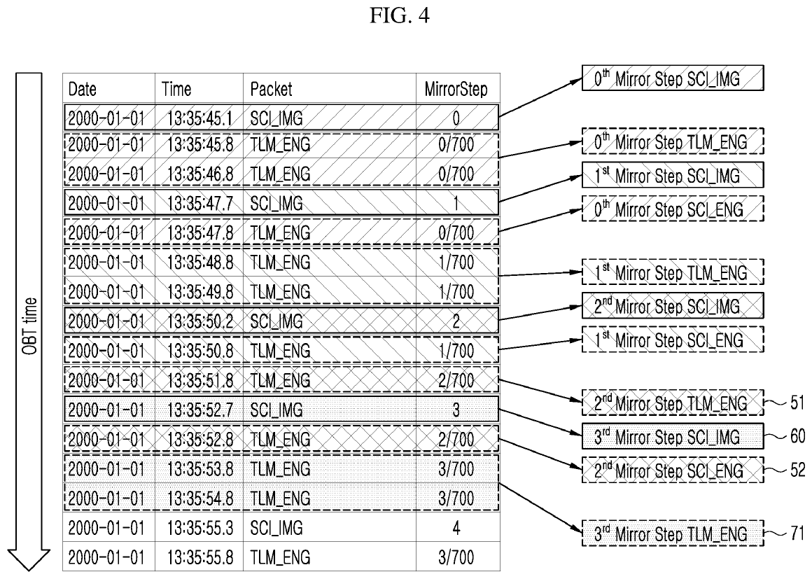

### DETAILED DESCRIPTION

Hereinafter, certain embodiments will be described in detail with reference to the accompanying drawings to help those with ordinary knowledge in the art easily achieve the present disclosure.

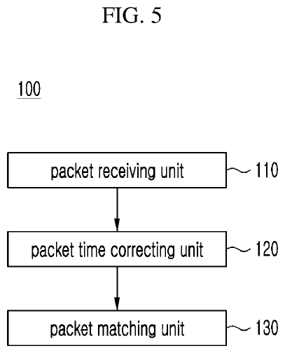

FIG. 5 illustrates a configuration of an apparatus for matching telemetry packets for satellite image processing.

Referring to FIG. 5, the apparatus 100 for matching telemetry packets for satellite image processing may include a packet receiving unit 110, a packet time correcting unit 120, and a packet matching unit 130.

The packet receiving unit 110 may receive a plurality of image data telemetry packets and a plurality of auxiliary data telemetry packets from a satellite (not illustrated).

The image data telemetry packets include satellite image data photographed from the satellite, but do not include observation target information, observation position information, or satellite image sequence information.

The auxiliary data telemetry packets include the satellite image sequence information. The auxiliary data telemetry packets may include the satellite image sequence information as well as various state information of the satellite payload, observation target information, observation position information, or the like.

The satellite image sequence information is given according to an order in which the satellite images are observed, i.e., photographed. For the images photographed by the satellite payload using the scan mirror, information indicating the mirror step, that is, the Mirror Step Count may be used.

The packet time correcting unit 120 may correct the packet time of a plurality of image data telemetry packets or a plurality of auxiliary data telemetry packets with a predetermined mathematical formula. For example, only the packet time of the image data telemetry packets or only the packet time of the auxiliary data telemetry packets may be corrected.

The satellite image may be generated through an image processing process of generating one satellite image frame by combining satellite image sub-frames photographed a plurality of times for the same integration time to reduce noise. This image processing process is referred to as co-addition or image stacking. The increased integration time can provide improved signal-to-noise ratio and reduced noise, but if the integration time is increased without limit, a situation may occur, in which the brightness of the photographed target exceeds a maximum measurable range of the sensor, resulting in saturated value. Therefore, an image processing process may be applied, which reduces the integration time to improve a dynamic range and generates a single image by combining the images photographed a plurality of times.

The packet time correction may be performed by Formula 1 below.

T_c=T+T_int×N_co-adding×Const+offset [Formula 1]

where, ‘T_c’ is a packet time after correction and ‘T’ is the satellite OBT time recorded in the packet at the time of generating the telemetry packet, that is, the packet time before correction. ‘T_int’ is an integration time per satellite image sub-frame, and ‘N_co-adding’ is a number of times the satellite image subframes are photographed. In addition, ‘Const’ and ‘offset’ may be correction coefficients that are predetermined.

In Formula 1, ‘T_int×N_co-adding’ is the total time required for photographing one satellite image frame. The auxiliary data telemetry packet and the image data telemetry packet may be deviated by ‘T_int×N_co-adding’, due to the difference in generation time that corresponds to the total integration time of the image. Therefore, the packet time correction may be performed by Formula 1.

The packet matching unit 130 may match the plurality of image data telemetry packets and the plurality of auxiliary data telemetry packets corresponding to the same satellite image sequence by using the packet time.

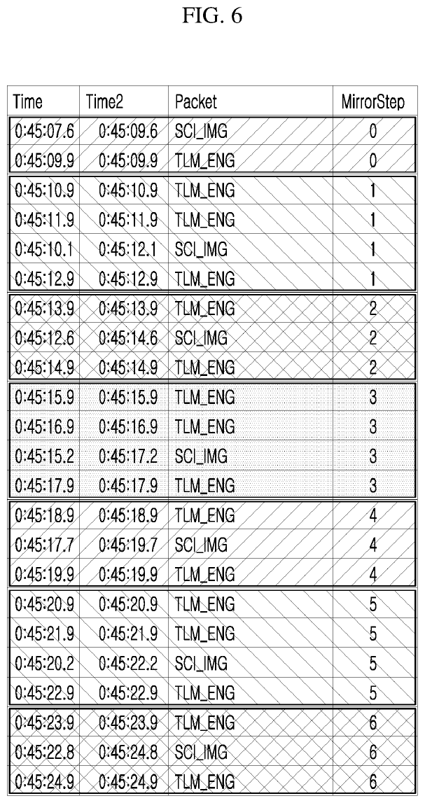

FIG. 6 illustrates an example in which the telemetry packets are aligned according to packet time sequence after packet time correction.

Referring to FIG. 6, for the image data telemetry packet (SCI_IMG), the packet time (Time) is corrected to the packet time (Time2) by Formula 1. In Formula 1, the image data telemetry packet time is corrected by applying 63.5 for T_int, 37 for N_co-adding, 1 for Const, and 0 for offset. For the auxiliary data telemetry packet (TLM_ENG), the packet time (Time) is not corrected. Accordingly, in FIG. 6, the packet time (Time) and the packet time (Time2) are same as each other in the auxiliary data telemetry packet.

By correcting the packet time of the image data telemetry packets and then aligning according to the corrected packet time (Time2), the packets are aligned as illustrated in FIG. 6. In FIG. 6, the Mirror Step corresponding to the satellite image sequence information of the image data telemetry packet is a value given by manually ordering the image packets after they are received, and the Mirror Step of the auxiliary data telemetry packet is a value included in the packet.

As illustrated in FIG. 6, by correcting the packet time of the image data telemetry packets by Formula 1 and then aligning the image data telemetry packets and the auxiliary data telemetry packets in order according to the packet time, it can be confirmed that the image data telemetry packets and the auxiliary data telemetry packets corresponding to the same satellite image sequence are positioned before and after each other.

Accordingly, the packet matching unit 130 may match the image data telemetry packet after the packet time correction to the auxiliary data telemetry packet of the auxiliary data telemetry packets that has the closest packet time. Accordingly, the image data telemetry packets and the auxiliary data telemetry packets corresponding to the same satellite image sequence may be matched.

Of course, the packet matching unit 130 may match the image data telemetry packet after the packet time correction to the auxiliary data telemetry packet of the auxiliary data telemetry packets that has the packet time immediately before or after the packet time of the image data telemetry packet. Accordingly, the image data telemetry packets and the auxiliary data telemetry packets corresponding to the same satellite image sequence may be matched.

FIG. 6 illustrates an example in which the packet time of the image data telemetry packet is corrected by Formula 1, but the image data telemetry packet and the auxiliary data telemetry packet corresponding to the same satellite image sequence may be matched by correcting the packet time of the auxiliary data telemetry packet according to Formula 1 and aligning according to the order of the packet time as described above. However, unlike the method of correcting the packet time of the image data telemetry packet, in the above case, Const and offset with opposite signs may be applied in Formula 1.

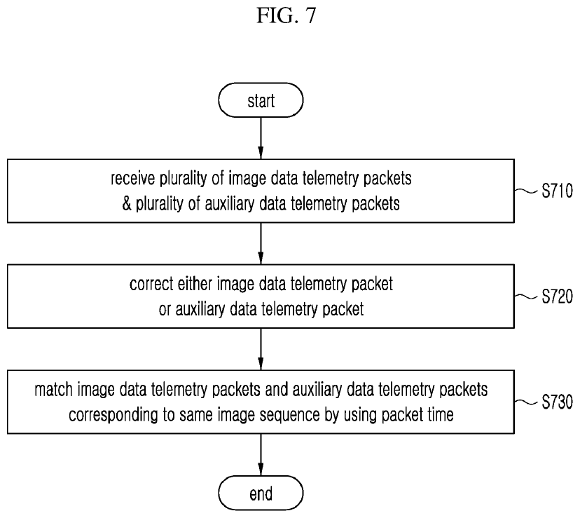

FIG. 7 is a flowchart illustrating operation of an apparatus for matching telemetry packets for satellite image processing.

Referring to FIG. 7, the apparatus 100 for matching telemetry packets may first receive a plurality of image data telemetry packets and a plurality of auxiliary data telemetry packets, at S710.

Next, the apparatus 100 for matching telemetry packets may correct the packet time of a plurality of image data telemetry packets or a plurality of auxiliary data telemetry packets by a predetermined mathematical formula, e.g., by Formula 1, at S720.

In addition, the apparatus 100 for matching telemetry packets may match the plurality of image data telemetry packets and the plurality of auxiliary data telemetry packets corresponding to the same satellite image sequence by using the packet time, at S730.

At S730, the apparatus 100 for matching telemetry packets may align a plurality of image data telemetry packets and a plurality of auxiliary data telemetry packets according to the packet time sequence, and match the image data telemetry packet to: 1) an auxiliary data telemetry packet of the auxiliary data telemetry packets that has the closest packet time; or 2) an auxiliary data telemetry packet of the auxiliary data telemetry packets that has the packet time immediately before or after the packet time of the image data telemetry packet.

The embodiments described above may be implemented as a hardware component, a software component, and/or a combination of a hardware component and a software component. For example, the devices, methods, and components described in the embodiments may be implemented by using one or more general computer or specific-purpose computer such as a processor, a controller, an arithmetic logic unit (ALU), a digital signal processor, a microcomputer, a field programmable gate array (FPGA), a programmable logic unit (PLU), a microprocessor, or any other device capable of executing instructions and responding thereto. The processing device may execute an operating system (OS) and one or more software applications executed on the operating system. Further, the processing device may access, store, operate, process, and generate data in response to the execution of software. For convenience of understanding, it is described in certain examples that one processing device is used, but one of ordinary skill in the art may understand that the processing device may include a plurality of processing elements and/or a plurality of types of processing elements. For example, the processing device may include a plurality of processors or one processor and one controller. In addition, other processing configurations such as a parallel processor are possible.

The software may include a computer program, code, instructions, or a combination of one or more of the above, and may configure the processing device, or instruct the processing device independently or collectively to operate as desired. Software and/or data may be interpreted by the processing device or, in order to provide instructions or data to the processing device, may be embodied in any type of machine, component, physical device, virtual equipment, computer storage medium or device, or signal wave transmission, permanently or temporarily. The software may be distributed over networked computer systems and stored or executed in a distributed manner. The software and data may be stored on one or more computer-readable recording media.

The method according to the embodiments may be implemented in the form of program instructions that can be executed through various computer means and recorded in a computer-readable medium. The computer readable medium may include program instructions, data files, data structures, and the like alone or in combination. The program instructions recorded on the medium may be those specially designed and configured for the purposes of the embodiments, or may be known and available to those skilled in computer software. Examples of computer readable recording medium include magnetic media such as hard disks, floppy disks, and magnetic tape, optical media such as CD-ROMs and DVDs, magneto-optical media such as floptical disks, and hardware devices specifically configured to store and execute program instructions such as ROM, RAM, flash memory, and the like. Examples of the program instructions include machine language codes such as those generated by a compiler, as well as high-level language codes that may be executed by a computer using an interpreter, and so on. The hardware device described above may be configured to operate as one or more software modules in order to perform the operations according to the embodiments, and vice versa.

As described above, although the embodiments have been described with reference to the limited drawings, a person of ordinary skill in the art can apply various technical modifications and variations based on the above. For example, even when the described techniques are performed in the order different from the method described above, and/or even when the components of the system, structure, device, circuit, and the like are coupled or combined in a form different from the way described above, or replaced or substituted by other components or equivalents, an appropriate result can be achieved.

1. A method for matching telemetry packets for satellite image processing, the method comprising:
receiving a plurality of image data telemetry packets and a plurality of auxiliary data telemetry packets, wherein the plurality of image data telemetry packets include satellite image data photographed from a satellite, but do not include satellite image sequence information, and the plurality of auxiliary data telemetry packets include satellite image sequence information;
correcting a packet time of either the plurality of image data telemetry packets or the plurality of auxiliary data telemetry packets by using a predetermined mathematical formula; and
matching the plurality of image data telemetry packets and the plurality of auxiliary data telemetry packets corresponding to the same satellite image sequence by using the packet time.

2. The method of claim 1, comprising matching the image data telemetry packet to an auxiliary data telemetry packet of the auxiliary data telemetry packets that has the closest packet time.

3. The method of claim 1, comprising matching the image data telemetry packet to an auxiliary data telemetry packet of the auxiliary data telemetry packets that has the packet time immediately before or after the packet time of the image data telemetry packet.

4. The method of claim 2, wherein the satellite image data is generated through an image processing process of generating one satellite image frame by combining satellite image sub-frames photographed a plurality of times for the same integration time, and
the predetermined mathematical formula is:
T_c=T+T_int×N_co-adding×Const+offset,
where, ‘T_c’ is the packet time after correction,
‘T’ is the packet time recorded in the packet at the time of generating the telemetry packet,
‘T_int’ is the integration time,
‘N_co-adding’ is a number of times the satellite image sub-frame is photographed, and
‘Const’ and ‘offset’ are correction coefficients that are predetermined.

5. A computer-readable recording medium storing a program for executing the method of claim 1 on a computer.

6. An apparatus for matching telemetry packets for satellite image processing, the apparatus comprising:
a packet receiving unit configured to receive a plurality of image data telemetry packets and a plurality of auxiliary data telemetry packets, wherein the plurality of image data telemetry packets include satellite image data photographed from a satellite, but do not include satellite image sequence information, and the plurality of auxiliary data telemetry packets include satellite image sequence information;
a packet time correction unit configured to correct a packet time of either the plurality of image data telemetry packets or the plurality of auxiliary data telemetry packets by using a predetermined mathematical formula; and
a packet matching unit configured to match the plurality of image data telemetry packets and the plurality of auxiliary data telemetry packets corresponding to the same satellite image sequence by using the packet time.

7. The apparatus of claim 6, wherein the packet matching unit matches the image data telemetry packet to an auxiliary data telemetry packet of the auxiliary data telemetry packets that has the closest packet time.

8. The apparatus of claim 6, wherein the packet matching unit matches the image data telemetry packet to an auxiliary data telemetry packet of the auxiliary data telemetry packets that has the packet time immediately before or after the packet time of the image data telemetry packet.

9. The apparatus of claim 7, wherein the satellite image data is generated through an image processing process of generating one satellite image frame by combining satellite image sub-frames photographed a plurality of times for the same integration time, and
the predetermined mathematical formula is:
T_c=T+T_int×N_co-adding×Const+offset,
where, ‘T_c’ is the packet time after correction,
‘T’ is the packet time recorded in the packet at the time of generating the telemetry packet,
‘T_int’ is the integration time,
‘N_co-adding’ is a number of times the satellite image sub-frame is photographed, and
‘Const’ and ‘offset’ are correction coefficients that are predetermined.
